(19) United States
(12) Patent Application Publication
(10) Pub. No.: US 2024/0380565 A1
(43) Pub. Date: Nov. 14, 2024

(54) UPLINK TRANSMISSIONS IN SUBBAND FULL DUPLEX SYMBOLS

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Abdelrahman Mohamed Ahmed Mohamed IBRAHIM, San Diego, CA (US)

(21) Appl. No.: 18/657,029

(22) Filed: May 7, 2024

Related U.S. Application Data
(60) Provisional application No. 63/501,940, filed on May 12, 2023.

(51) Int. Cl. H04L 5/14; H04W 56/00; H04W 72/1268; H04W 72/232; H04W 72/566; H04W 76/20

(52) U.S. Cl. CPC H04L 5/14; H04W 56/0015; H04W 72/1268; H04W 72/232; H04W 72/566; H04W 76/20

(57) ABSTRACT

Various aspects of the present disclosure generally relate to wireless communication. In some aspects, a user equipment (UE) may receive a configuration, from a network, associated with a downlink transmission in one or more subband full duplex (SBFD) symbols. Accordingly, the UE may selectively transmit an uplink transmission in the one or more SBFD symbols based at least in part on the configuration. Additionally, or alternatively, the UE may receive a configuration, from the network, associated with a random access channel occasion in one or more SBFD symbols. Accordingly, the UE may selectively receive a downlink transmission in the one or more SBFD symbols based at least in part on the configuration. Numerous other aspects are described.

### CROSS-REFERENCE TO RELATED APPLICATION

This Patent application claims priority to U.S. Provisional Application No. 63/501,940, filed on May 12, 2023, entitled “UPLINK TRANSMISSIONS IN SUBBAND FULL DUPLEX SYMBOLS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for transmitting and receiving uplink transmissions in subband full duplex symbols.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration, from a network, associated with a downlink transmission in one or more subband full duplex (SBFD) symbols. The method may include selectively transmitting an uplink transmission in the one or more SBFD symbols based at least in part on the configuration.

Some aspects described herein relate to a method of wireless communication performed by a network node. The method may include transmitting a configuration associated with a downlink transmission in one or more SBFD symbols. The method may include selectively monitoring for an uplink transmission in the one or more SBFD symbols based at least in part on the configuration.

Some aspects described herein relate to a method of wireless communication performed by a UE. The method may include receiving a configuration, from a network, associated with a random access channel occasion (RO) in one or more SBFD symbols. The method may include selectively receiving a downlink transmission in the one or more SBFD symbols based at least in part on the configuration.

Some aspects described herein relate to a method of wireless communication performed by a network node. The method may include transmitting a configuration associated with an RO in one or more SBFD symbols. The method may include selectively transmitting a downlink transmission in the one or more SBFD symbols based at least in part on the configuration.

Some aspects described herein relate to a non-transitory computer-readable medium that stores a set of instructions for wireless communication by a UE. The set of instructions, when executed by one or more processors of the UE, may cause the UE to receive a configuration, from a network, associated with a downlink transmission in one or more SBFD symbols. The set of instructions, when executed by one or more processors of the UE, may cause the UE to selectively transmit an uplink transmission in the one or more SBFD symbols based at least in part on the configuration.

Some aspects described herein relate to a non-transitory computer-readable medium that stores a set of instructions for wireless communication by a network node. The set of instructions, when executed by one or more processors of the network node, may cause the network node to transmit a configuration associated with a downlink transmission in one or more SBFD symbols. The set of instructions, when executed by one or more processors of the network node, may cause the network node to selectively monitor for an uplink transmission in the one or more SBFD symbols based at least in part on the configuration.

Some aspects described herein relate to a non-transitory computer-readable medium that stores a set of instructions for wireless communication by a UE. The set of instructions, when executed by one or more processors of the UE, may cause the UE to receive a configuration, from a network, associated with an RO in one or more SBFD symbols. The set of instructions, when executed by one or more processors of the UE, may cause the UE to selectively receive a downlink transmission in the one or more SBFD symbols based at least in part on the configuration.

Some aspects described herein relate to a non-transitory computer-readable medium that stores a set of instructions for wireless communication by a network node. The set of instructions, when executed by one or more processors of the network node, may cause the network node to transmit a configuration associated with an RO in one or more SBFD symbols. The set of instructions, when executed by one or more processors of the network node, may cause the network node to selectively transmit a downlink transmission in the one or more SBFD symbols based at least in part on the configuration.

Some aspects described herein relate to an apparatus for wireless communication at a UE. The apparatus may include one or more memories and one or more processors coupled to the one or more memories. The one or more processors may be configured to receive a configuration, from a network, associated with a downlink transmission in one or more SBFD symbols. The one or more processors may be configured to selectively transmit an uplink transmission in the one or more SBFD symbols based at least in part on the configuration.

Some aspects described herein relate to an apparatus for wireless communication at a network node. The apparatus may include one or more memories and one or more processors coupled to the one or more memories. The one or more processors may be configured to transmit a configuration associated with a downlink transmission in one or more SBFD symbols. The one or more processors may be configured to selectively monitor for an uplink transmission in the one or more SBFD symbols based at least in part on the configuration.

Some aspects described herein relate to an apparatus for wireless communication at a UE. The apparatus may include one or more memories and one or more processors coupled to the one or more memories. The one or more processors may be configured to receive a configuration, from a network, associated with an in one or more SBFD symbols. The one or more processors may be configured to selectively receive a downlink transmission in the one or more SBFD symbols based at least in part on the configuration.

Some aspects described herein relate to an apparatus for wireless communication at a network node. The apparatus may include one or more memories and one or more processors coupled to the one or more memories. The one or more processors may be configured to transmit a configuration associated with an RO in one or more SBFD symbols. The one or more processors may be configured to selectively transmit a downlink transmission in the one or more SBFD symbols based at least in part on the configuration.

Some aspects described herein relate to an apparatus for wireless communication. The apparatus may include means for receiving a configuration, from a network, associated with a downlink transmission in one or more SBFD symbols. The apparatus may include means for selectively transmitting an uplink transmission in the one or more SBFD symbols based at least in part on the configuration.

Some aspects described herein relate to an apparatus for wireless communication. The apparatus may include means for transmitting a configuration associated with a downlink transmission in one or more SBFD symbols. The apparatus may include means for selectively monitoring for an uplink transmission in the one or more SBFD symbols based at least in part on the configuration.

Some aspects described herein relate to an apparatus for wireless communication. The apparatus may include means for receiving a configuration, from a network, associated with an RO in one or more SBFD symbols. The apparatus may include means for selectively receiving a downlink transmission in the one or more SBFD symbols based at least in part on the configuration.

Some aspects described herein relate to an apparatus for wireless communication. The apparatus may include means for transmitting a configuration associated with an RO in one or more SBFD symbols. The apparatus may include means for selectively transmitting a downlink transmission in the one or more SBFD symbols based at least in part on the configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating an example disaggregated base station architecture, in accordance with the present disclosure.

FIG. 4 is a diagram illustrating an example of subband full duplex (SBFD), in accordance with the present disclosure.

FIGS. 5A, 5B, and 5C are diagrams illustrating examples of full duplex communication in accordance with the present disclosure.

FIGS. 6A, 6B, and 7 are diagrams illustrating examples associated with uplink transmissions in SBFD symbols, in accordance with the present disclosure.

FIGS. 8A, 8B, and 9 are diagrams illustrating examples associated with downlink transmissions in SBFD symbols, in accordance with the present disclosure.

FIGS. 10, 11, 12, and 13 are diagrams illustrating example processes associated with transmissions in SBFD symbols, in accordance with the present disclosure.

FIGS. 14 and 15 are diagrams of example apparatuses for wireless communication, in accordance with the present disclosure.

### DETAILED DESCRIPTION

A user equipment (UE) may receive or transmit using subband full duplex (SBFD). In SBFD, frequencies of slots and symbols are divided such that some frequencies are associated with downlink and other frequencies are associated with uplink. As used herein, “slot” may refer to a portion of a subframe, which in turn may be a fraction of a radio frame within an LTE, 5G, or another wireless communication structure. In some aspects, a slot may include one or more symbols. Additionally, “symbol” may refer to an OFDM symbol or another similar symbol within a slot. A UE may be configured to perform various measurements (e.g., on synchronization signal blocks (SSBs), channel state information reference signals (CSI-RSs), radio link management (RLM) reference signals (RLM-RSs), and/or tracking reference signals (TRSs), among other examples) and receive common downlink communications (e.g., in an initial common search space (also referred to as “CSS 0” or “CSS #0”) and/or using an initial control resource set (also referred to a “CORESET 0” or “CORESET #0)). However, downlink transmissions such as reference signals and common downlink communications are not always transmitted. Accordingly, the UE suffers increased latency when an SBFD symbol is reserved for a reference signal or a common downlink communication because the UE is unable to transmit in the uplink frequencies. Similarly, a UE may be configured with occasions to transmit a random access channel (RACH) preamble. However, when the UE does not transmit a preamble in a RACH occasion (RO), the UE is generally not allowed to receive in symbols that include the RO. Accordingly, the UE suffers increased latency when an SBFD symbol is reserved for an RO because the UE is unable to receive in the downlink frequencies.

Various aspects relate generally to wireless communication and more particularly to configuring a UE for selective uplink transmissions even when a downlink transmission is configured in one or more SBFD symbols. Some aspects more specifically relate to explicitly indicating when the UE may transmit. For example, a network may use radio resource control (RRC) parameters to control when the UE transmits. Alternatively, the UE may determine when to transmit. For example, the UE may determine to transmit when the downlink transmission is not expected or when UE is not configured, or indicated, to measure a downlink signal. Various additional or alternative aspects relate more particularly to configuring a UE for selective downlink receptions even when an RO is scheduled in one or more SBFD symbols. Some aspects more specifically relate to explicitly indicating when the UE may receive. For example, a network may use RRC parameters to control when the UE receives. Alternatively, the UE may determine when to receive. For example, the UE may determine to receive only some types of transmissions in the one or more SBFD symbols.

Particular aspects of the subject matter described in this disclosure can be implemented to realize one or more of the following potential advantages. In some examples, because the UE selectively transmits in one or more SBFD symbols, the described techniques can be used to reduce uplink latency. Similarly, in some examples, because the UE selectively receives in one or more SBFD symbols, the described techniques can be used to reduce downlink latency. In some aspects, the network may explicitly indicate when the UE may transmit and/or receive in the one or more SBFD symbols in order to conserve power and processing resources at the UE. Alternatively, the UE may determine when to transmit and/or receive in the one or more SBFD symbols in order to reduce network overhead.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

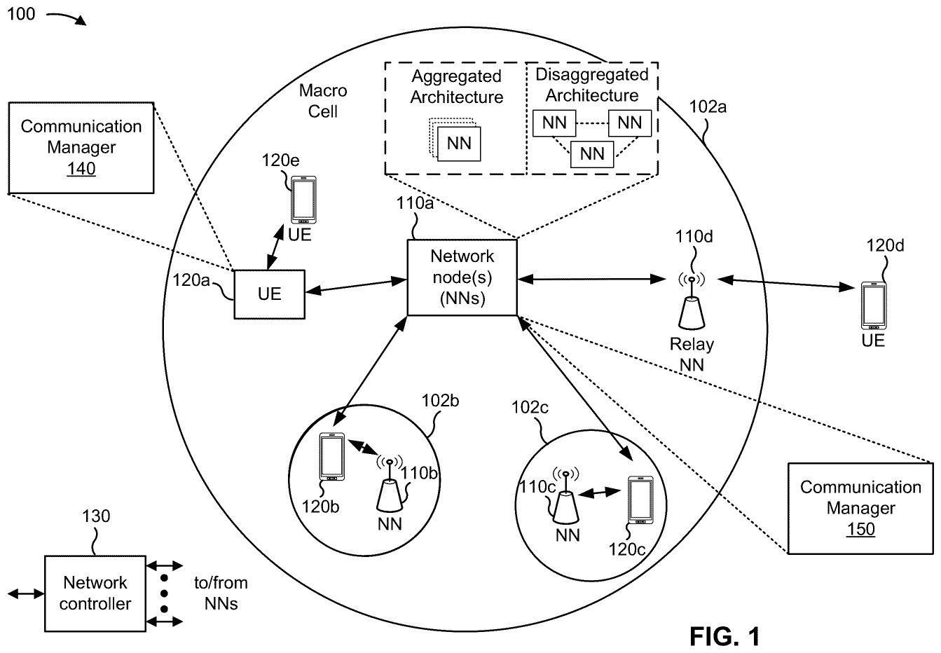

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration (e.g., from the network node 110) associated with a downlink transmission in one or more SBFD symbols and may selectively transmit an uplink transmission in the one or more SBFD symbols based at least in part on the configuration. Additionally, or alternatively, the communication manager 140 may receive a configuration (e.g., from the network node 110) associated with an RO in one or more SBFD symbols and may selectively receive a downlink transmission in the one or more SBFD symbols based at least in part on the configuration. Additionally, or alternatively, the communication manager 140 may perform one or more other operations described herein.

In some aspects, the network node 110 may include a communication manager 150. As described in more detail elsewhere herein, the communication manager 150 may transmit a configuration associated with a downlink transmission in one or more SBFD symbols and may selectively monitor for an uplink transmission in the one or more SBFD symbols based at least in part on the configuration. Additionally, or alternatively, the communication manager 150 may transmit a configuration associated with an RO in one or more SBFD symbols and may selectively transmit a downlink transmission in the one or more SBFD symbols based at least in part on the configuration. Additionally, or alternatively, the communication manager 150 may perform one or more other operations described herein.

As indicated above, FIG. 1 is provided as an example. Other examples may differ from what is described with regard to FIG. 1.

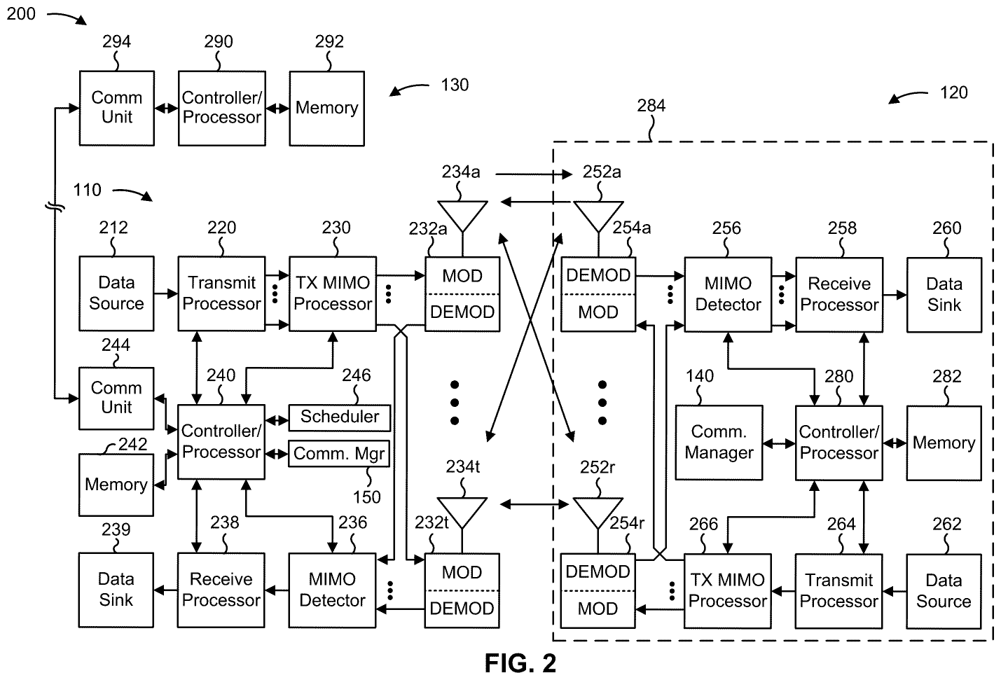

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

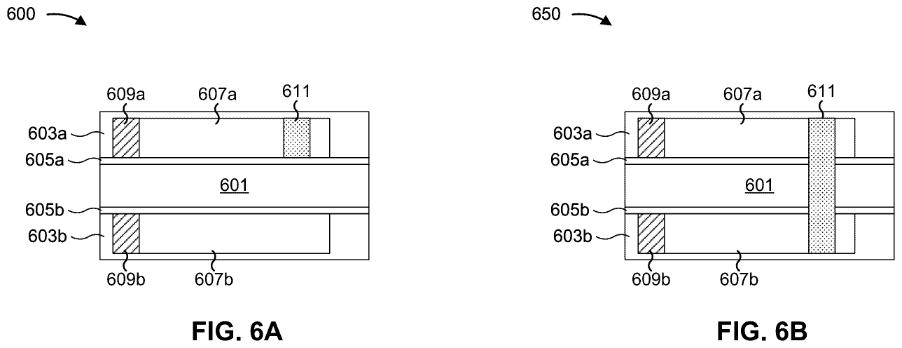

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-15).

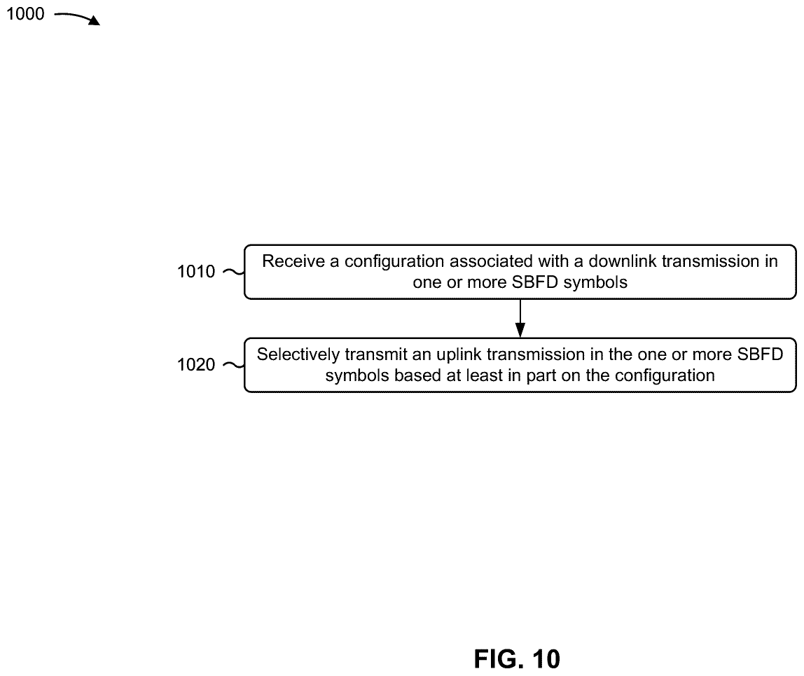

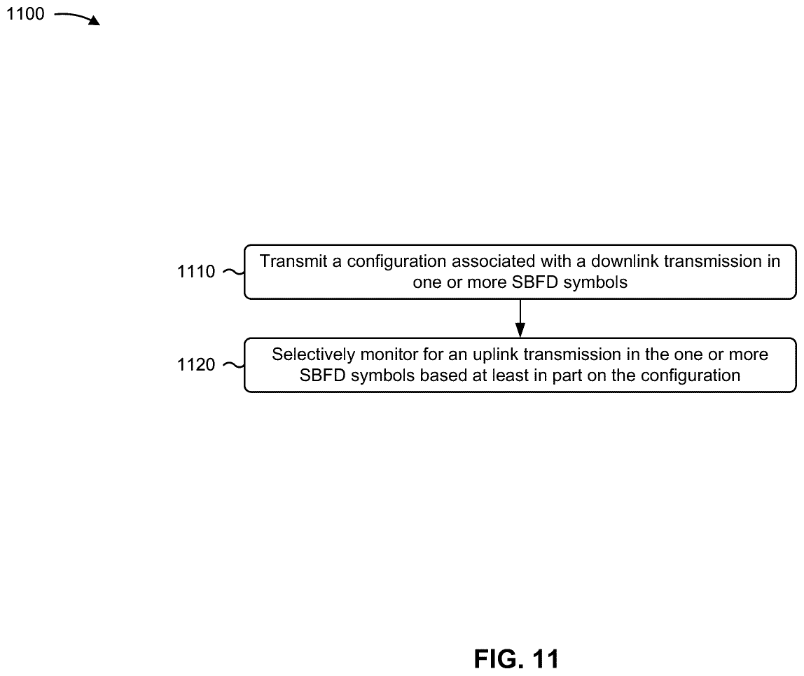

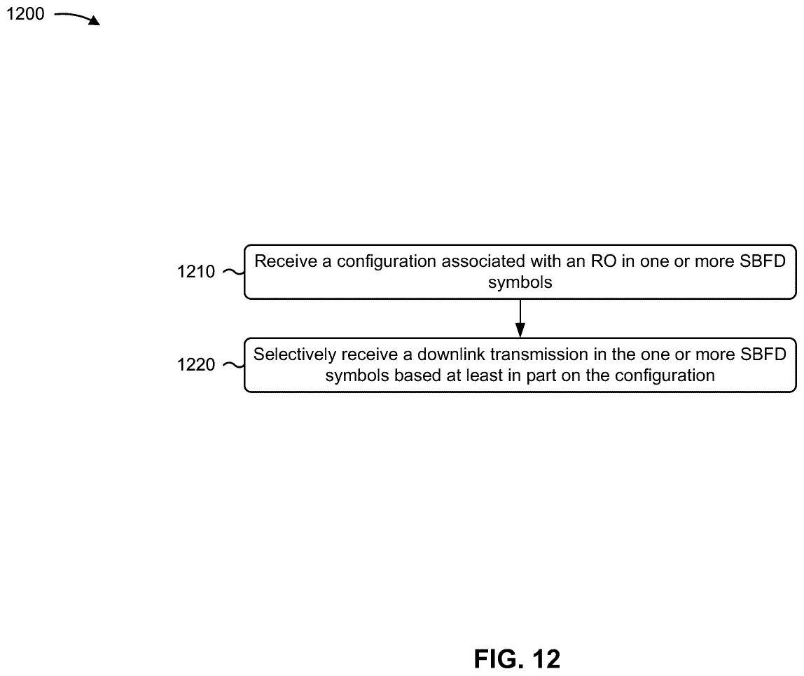

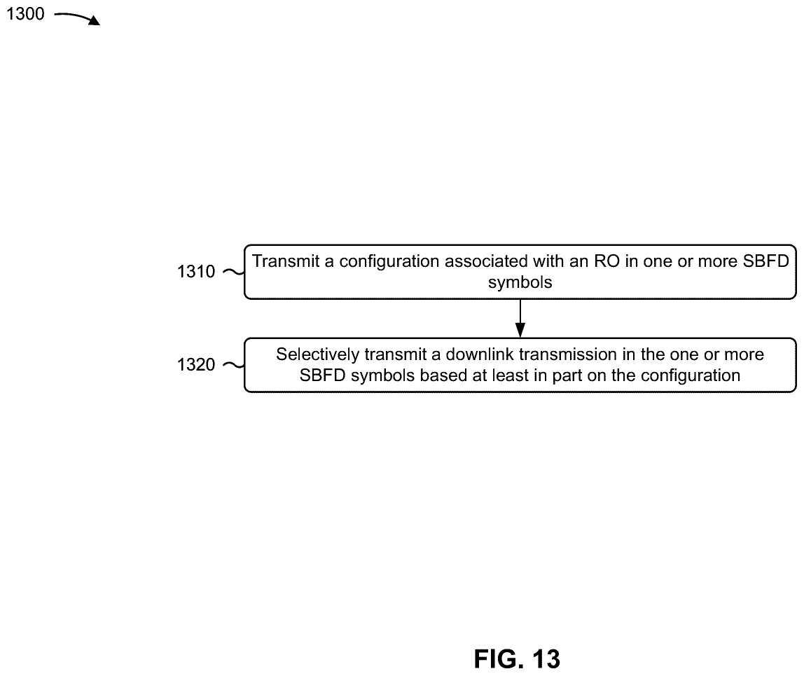

The controller/processor 240 of the network node 110, the controller/processor 280 of the UE 120, and/or any other component(s) of FIG. 2 may perform one or more techniques associated with transmitting and receiving uplink transmissions in SBFD symbols, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

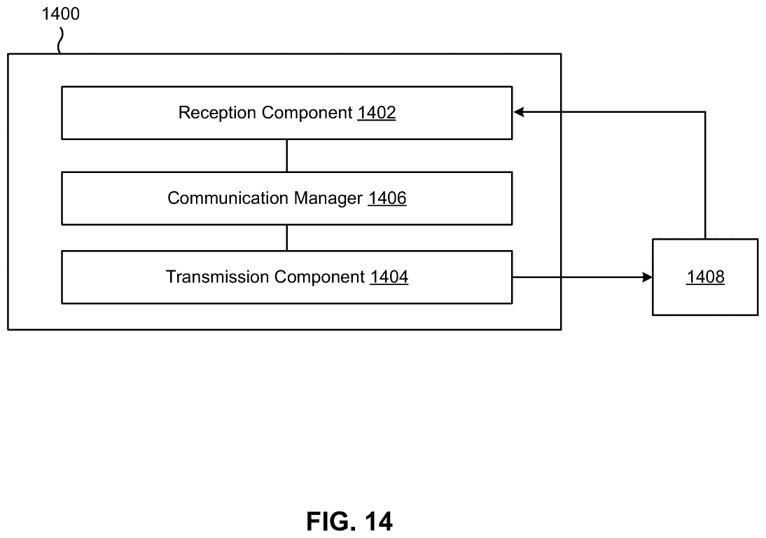

In some aspects, a UE (e.g., the UE 120 and/or apparatus 1400 of FIG. 14) may include means for receiving a configuration, from a network, associated with a downlink transmission in one or more SBFD symbols and/or means for selectively transmitting an uplink transmission in the one or more SBFD symbols based at least in part on the configuration. Additionally, or alternatively, the UE may include means for receiving a configuration, from a network, associated with an RO in one or more SBFD symbols and/or means for selectively receiving a downlink transmission in the one or more SBFD symbols based at least in part on the configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

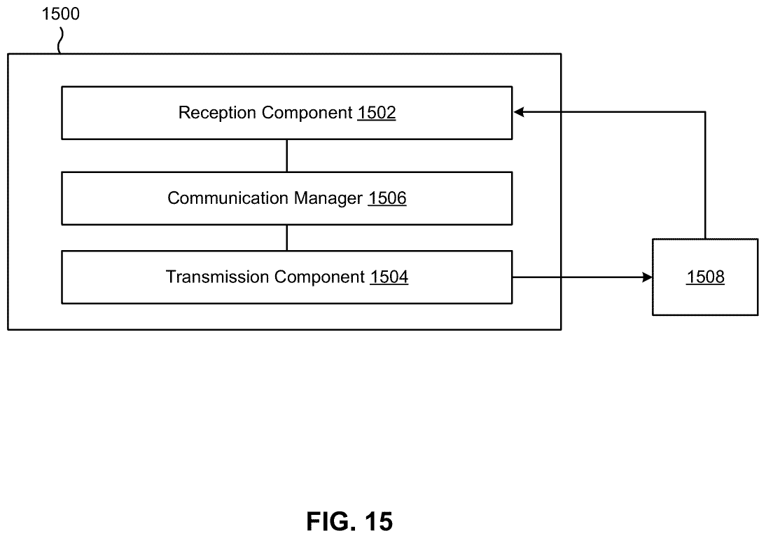

In some aspects, a network node (e.g., the network node 110, an RU 340, a DU 330, a CU 310, and/or apparatus 1500 of FIG. 15) may include means for transmitting a configuration associated with a downlink transmission in one or more SBFD symbols and/or means for selectively monitoring for an uplink transmission in the one or more SBFD symbols based at least in part on the configuration. Additionally, or alternatively, the network node may include means for transmitting a configuration associated with an RO in one or more SBFD symbols and/or means for selectively transmitting a downlink transmission in the one or more SBFD symbols based at least in part on the configuration. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

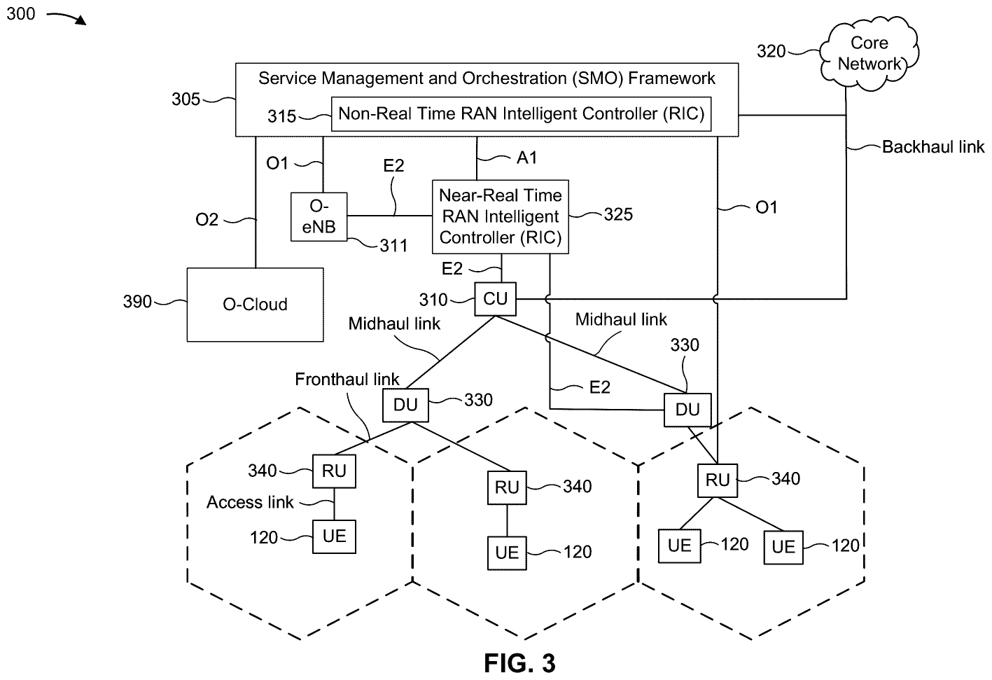

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through FI interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

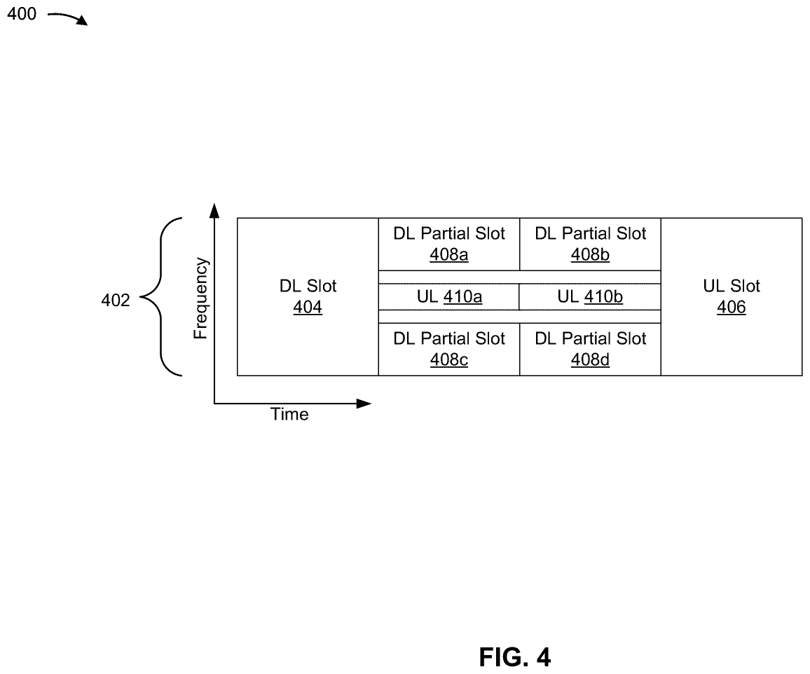

FIG. 4 is a diagram illustrating an example 400 of SBFD, in accordance with the present disclosure. As shown in FIG. 4, example 400 includes a configuration 402. In some aspects, first configuration 402 may indicate a slot format pattern (sometimes called a time division duplex (TDD) pattern) associated with a full-duplex mode. The slot format pattern may include a quantity of downlink slots (e.g., downlink slot 404, as shown), a quantity of flexible slots (not shown), and/or a quantity of uplink slots (e.g., uplink slot 406, as shown). The slot format pattern may repeat over time. In some aspects, a network node 110 may indicate the slot format pattern to a UE 120 using one or more slot format indicators (SFIs). An SFI, for a slot, may indicate whether that slot is an uplink slot, a downlink slot, or a flexible slot, among other examples.

In example 400, the slot format pattern further includes two SBFD slots. In example 400, each SBFD slot includes a partial slot (e.g., a portion or sub-band of a frequency allocated for use by the network node 110 and the UE 120) for downlink (e.g., partial slots 408a, 408b, 408c, and 408d, as shown) and a partial slot for uplink (e.g., partial slots 410a and 410b, as shown). Accordingly, the UE 120 may operate using the SBFD slots to transmit an uplink communication in an earlier slot (e.g., the second slot in sequence, shown as partial slot 410a) as compared to using the non-SBFD slots (e.g., the fourth slot in sequence, shown as UL slot 406). An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band, as described in connection with FIG. 6. In some aspects, the SBFD format may include multiple downlink portions and a single uplink portion that is separated from the multiple downlink portions by respective guard bands (e.g., as shown in FIG. 4). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using a full duplex (FD) mode in one or more slots based at least in part on the one or more slots having the SBFD format. A slot may support the SBFD mode if an UL bandwidth part (BWP) and a DL BWP are permitted to be or are simultaneously active in the slot in an SBFD fashion (e.g., with guard band separation).

Some techniques and apparatuses described herein enable the UE 120 to selectively transmit in SBFD slots (e.g., in the partial slots 410a and/or 410b) even when a downlink transmission is configured in the SBFD slots. As a result, the UE 120 experiences decreased uplink latency. Additionally, or alternatively, some techniques and apparatuses described herein enable the network node 110 to selectively transmit in SBFD slots (e.g., in the partial slots 408a, 408b, 408c, and/or 408d) even when an RO is configured in the SBFD slots. As a result, the UE 120 experiences decreased downlink latency.

As indicated above, FIG. 4 is provided as an example. Other examples may differ from what is described with respect to FIG. 4.

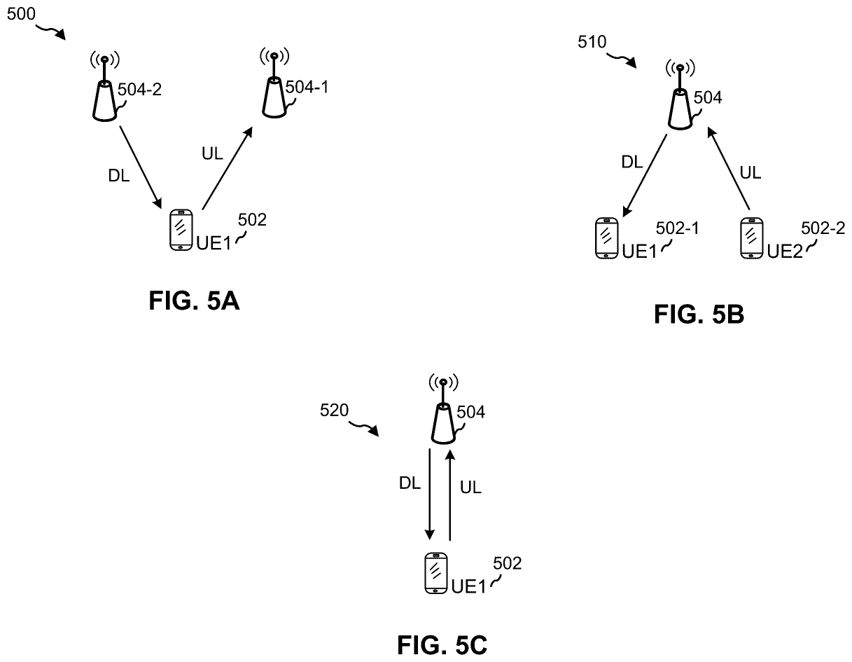

FIGS. 5A-5C are diagrams illustrating examples 500, 510, 520 of FD communication in accordance with the present disclosure. The example 500 of FIG. 5A includes a UE1 502 and two TRPs 504-1, 504-2, where the UE1 502 is sending UL transmissions to TRP 504-1 and is receiving DL transmissions from TRP 504-2. In the example 500 of FIG. 5A, FD is enabled for the UE1 502, but not for the TRPs 504-1, 504-2. The example 510 of FIG. 5B includes two UEs, shown as UE1 502-1 and UE2 502-2, and a TRP 504, where the UE1 502-1 is receiving a DL transmission from the TRP 504 and the UE2 502-2 is transmitting an UL transmission to the TRP 504. In the example 510 of FIG. 5B, FD is enabled for the TRP 504, but not for UE1 502-1 and UE2 502-2. The example 520 of FIG. 5C includes a UE1 502 and a TRP 504, where the UE1 502 is receiving a DL transmission from the TRP 504 and the UE1 502 is transmitting an UL transmission to the TRP 504. In the example 520 of FIG. 5C, FD is enabled for both the UE1 502 and the TRP 504.

Some techniques and apparatuses described herein enable the UE 120 to selectively transmit, even when a downlink transmission is configured in SBFD slots, in order to further take advantage of FD operations and reduce latency. Additionally, or alternatively, some techniques and apparatuses described herein enable the TRP 504 to selectively transmit, even when an RO is configured in SBFD slots, in order to further take advantage of FD operations and reduce latency.

As indicated above, FIGS. 5A-5C are provided as one or more examples. Other examples may differ from what is described with regard to FIGS. 5A-5C.

FIGS. 6A and 6B are diagrams illustrating an example 600 and an example 650, respectively, associated with uplink transmissions in SBFD symbols, in accordance with the present disclosure. As shown in FIG. 6A, example 600 includes an SBFD slot (or a portion thereof) for a UE 120. The SBFD slot may include an uplink subband 601. Although the example 600 is shown with a single uplink subband, other examples may include a plurality of uplink subbands. The SBFD slot further includes a first downlink subband 603a and a second downlink subband 603b. Although the example 600 is shown with two downlink subbands, other examples may include three or more downlink subbands. In some aspects, the first downlink subband 603a and the uplink subband 601 are separated by a first guard band 605a, and the second downlink subband 603b and the uplink subband 601 are separated by a second guard band 605b. Other examples may omit the guard bands 605a and 605b.

Each downlink subband may be configured with a downlink channel. For example, the first downlink subband 603a may be configured for a physical downlink shared channel (PDSCH) 607a that includes a corresponding DMRS 609a. Similarly, the second downlink subband 603b may be configured for a PDSCH 607b that includes a corresponding DMRS 609b. Therefore, the UE 120 may be configured to transmit on the uplink subband 601 or to receive on the first downlink subband 603a and/or the second downlink subband 603b.

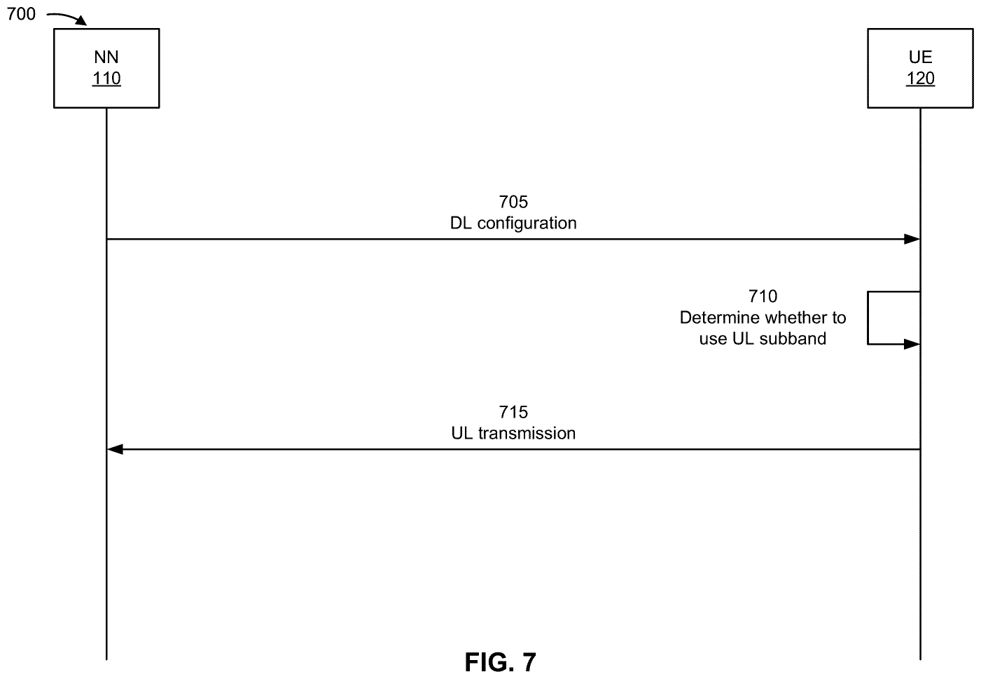

As further shown in FIG. 6A, a network may configure a downlink transmission 611 in the SBFD slot. For example, the downlink transmission 611 may include a transmission associated with CSS 0, a transmission associated with CORESET 0, a TRS, a CSI-RS, a reference signal for RLM or radio resource management (RRM), and/or an SSB, among other examples. In some aspects, the downlink transmission 611 may include an SSB associated with an SSB measurement timing configuration (SMTC). Accordingly, as described in connection with FIG. 7, the UE 120 may determine whether to use the uplink subband 601 based on whether the SSB is indicated for measurement, whether the SSB is associated with a measurement gap, and/or an RRC parameter from a network. Similarly, the downlink transmission 611 may include an SSB associated with a serving cell. Accordingly, as described in connection with FIG. 7, the UE 120 may determine whether to use the uplink subband 601 based on whether the SSB is indicated for measurement.

In FIG. 6A, the downlink transmission 611 is included in the first downlink subband 603a in the SBFD slot. Other examples may include the downlink transmission 611 additionally or alternatively included in the second downlink subband 603b in the SBFD slot. Example 650 of FIG. 6B is similar to example 600 of FIG. 6A except that the downlink transmission 611 is included in the uplink subband 601 in the SBFD slot.

As indicated above, FIGS. 6A-6B are provided as examples. Other examples may differ from what is described with respect to FIGS. 6A-6B.

FIG. 7 is a diagram illustrating an example 700 associated with uplink transmissions in SBFD symbols, in accordance with the present disclosure. As shown in FIG. 7, a network node 110 and a UE 120 may communicate with one another (e.g., using a wireless network, such as wireless network 100 of FIG. 1). The network node 110 may communicate directly (e.g., using an RU 340) or indirectly (e.g., by using a controller of the RU 340, such as a DU 330 and/or a CU 310).

As shown by reference number 705, the network node 110 may transmit, and the UE 120 may receive, a configuration associated with a downlink transmission. The downlink transmission may be located in one or more SBFD symbols (e.g., as described in connection with FIGS. 6A and 6B).

In one example, the downlink transmission includes an SSB associated with a serving cell. Accordingly, the configuration may include an ssb-PositionsinBurst parameter included in a system information broadcast (SIB) message (e.g., a SIB1 message) or a ServingCellConfigCommon RRC message, as defined in 3GPP specifications. In another example, the downlink transmission includes an SSB associated with an SMTC (e.g., indicated in a SIB2 message or a SIB4 message). Accordingly, the configuration may include an ssb-ToMeasure parameter included in an RRC message, as defined in 3GPP specifications.

In another example, the downlink transmission includes a CSI-RS. For example, the configuration may include a CSI-ResourceConfig information element (IE) in an RRC message, as defined in 3GPP specifications. In another example, the downlink transmission includes a TRS. Accordingly, the configuration may include an NZP-CSI-RS-ResourceSet IE with a trs-Info parameter in an RRC message, as defined in 3GPP specifications. The downlink transmission may additionally or alternatively include a reference signal used for RLM (e.g., as described in 3GPP specifications) rather than RRM. Accordingly, the configuration may include an RLM configuration and/or an rlmInSyncOutOfSyncThreshold parameter in an RRC message, as defined in 3GPP specification.

In another example, the downlink transmission may be associated with CSS 0 and/or CORESET 0. Accordingly, the configuration may include a machine information broadcast (MIB) message.

As shown by reference number 710, the UE 120 may determine whether to transmit in the one or more SBFD symbols based at least in part on the configuration. In some aspects, the downlink transmission may include an SSB associated with a serving cell. Accordingly, the UE 120 may determine to refrain from transmitting (and the network node 110 may determine to refrain from monitoring) based on the configuration indicating that the SSB is indicated for measurement. For example, the SSB may be indicated in the ssb-PositionsInBurst parameter (e.g., associated with a one) such that the UE 120 measures the SSB rather than transmitting in the one or more SBFD symbols. The SSB may be included in one or more downlink subbands (e.g., as described in connection with FIG. 6A) and/or at least one uplink subband (e.g., as described in connection with FIG. 6B).

Alternatively, the UE 120 may determine to transmit (and the network node 110 may determine to monitor) based on the configuration indicating that the SSB is not indicated for measurement. For example, the SSB may not be indicated in the ssb-PositionsInBurst parameter (e.g., associated with a zero) such that the UE 120 transmits in the one or more SBFD symbols. In some aspects, the UE 120 may determine to transmit further based on an uplink transmission being scheduled by downlink control information (DCI) but may determine to refrain from transmitting for a configured uplink transmission scheduled by a higher layer parameter (e.g., scheduled by RRC and/or a MAC control element (MAC-CE)). Accordingly, the UE 120 may transmit only dynamic uplink transmissions in the one or more SBFD symbols. Alternatively, the UE 120 may transmit both dynamic and configured uplink transmissions in the one or more SBFD symbols. Additionally, or alternatively, the UE 120 may determine to transmit further based on a priority associated with an uplink transmission. For example, the UE 120 may transmit only uplink transmissions associated with a priority that satisfies a priority threshold. The UE 120 may apply similar rules for CSI-RSs, TRSs, RLM-RSs, transmissions associated with CORESET 0, and/or transmissions associated with CSS 0.

In some aspects, the downlink transmission may include an SSB associated with an SMTC. Accordingly, the UE 120 may determine to refrain from transmitting (and the network node 110 may determine to refrain from monitoring) based on the configuration indicating that the SSB is indicated for measurement. For example, the SSB may be indicated in the SSB-toMeasure parameter (e.g., associated with a one) such that the UE 120 measures the SSB rather than transmitting in the one or more SBFD symbols. The SSB may be included in one or more downlink subbands (e.g., as described in connection with FIG. 6A) and/or at least one uplink subband (e.g., as described in connection with FIG. 6B). Additionally, or alternatively, the UE 120 may determine to refrain from transmitting (and the network node 110 may determine to refrain from monitoring) based on the SSB being associated with a measurement gap. For example, the UE 120 may adjust a local oscillator (LO) of the UE 120 because the SSB is associated with a different beam and/or a different BWP than the one or more SBFD symbols and thus is unable to transmit using the uplink subband.

Alternatively, the UE 120 may determine to transmit (and the network node 110 may determine to monitor) based on the configuration indicating that the SSB is not indicated for measurement. For example, the SSB may not be indicated in the SSB-toMeasure parameter (e.g., associated with a zero) such that the UE 120 transmits in the one or more SBFD symbols. In some aspects, the UE 120 may determine to transmit further based on an uplink transmission being scheduled by DCI but may determine to refrain from transmitting for a configured uplink transmission scheduled by a higher layer parameter (e.g., scheduled by RRC and/or a MAC-CE). Accordingly, the UE 120 may transmit only dynamic uplink transmissions in the one or more SBFD symbols. Alternatively, the UE 120 may transmit both dynamic and configured uplink transmissions in the one or more SBFD symbols. Additionally, or alternatively, the UE 120 may determine to transmit further based on a priority associated with an uplink transmission. For example, the UE 120 may transmit only uplink transmissions associated with a priority that satisfies a priority threshold. Additionally, or alternatively, the UE 120 may determine to transmit based on an RRC parameter from the network node 110. For example, the RRC parameter may include a bitmap that indicates which SSB occasions in the SMTC the UE 120 may use for transmitting. Alternatively, the RRC parameter may include a single field that applies to all SSB occasions in the SMTC or to SSB occasions not indicated for measurement in the SMTC. The bitmap or the single field may apply to a single SMTC window or may be associated with a pattern in time (e.g., a periodicity that is a multiple of a periodicity of the SMTC such that the UE 120 may transmit during at least some SSB occasions in periodic SMTC windows). The UE 120 may apply similar rules for CSI-RSs, TRSs, RLM-RSs, transmissions associated with CORESET 0, and/or transmissions associated with CSS 0.

As shown by reference number 715, the UE 120 selectively transmits, and the network node 110 selectively monitors, in the one or more SBFD symbols. For example, the UE 120 transmits, or refrains from transmitting, in an uplink subband of the one or more SBFD symbols according to the determination described in connection with reference number 710. Similarly, the network node 110 monitors, or refrains from monitoring, in the uplink subband of the one or more SBFD symbols according to the determination described in connection with reference number 710.

By using techniques as described in connection with FIG. 7, the UE 120 may selectively transmit in the one or more SBFD symbols that are configured for the downlink transmission. As a result, the UE 120 reduces uplink latency with the network node 110.

As indicated above, FIG. 7 is provided as an example. Other examples may differ from what is described with respect to FIG. 7.

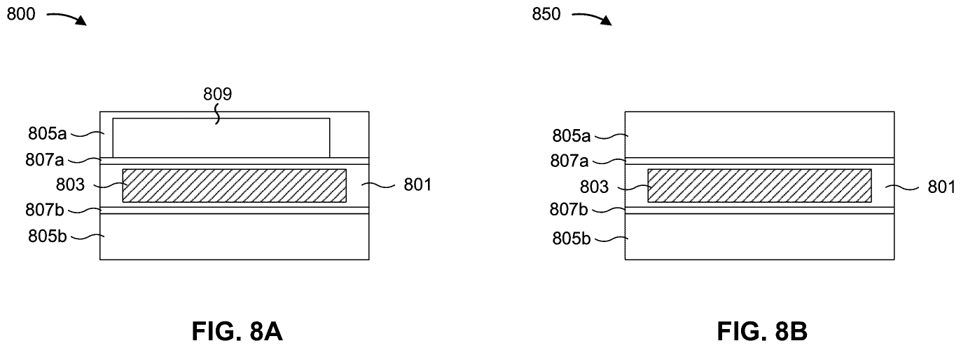

FIGS. 8A and 8B are diagrams illustrating an example 800 and an example 850, respectively, associated with downlink transmissions in SBFD symbols, in accordance with the present disclosure. As shown in FIG. 8A, example 800 includes an SBFD slot (or a portion thereof) for a UE 120. The SBFD slot may include an uplink subband 801. Although the example 800 is shown with a single uplink subband, other examples may include a plurality of uplink subbands. The uplink subband 801 includes an RO 803.

The SBFD slot further includes a first downlink subband 805a and a second downlink subband 805b. Although the example 800 is shown with two downlink subbands, other examples may include three or more downlink subbands. In some aspects, the first downlink subband 805a and the uplink subband 801 are separated by a first guard band 807a, and the second downlink subband 805b and the uplink subband 801 are separated by a second guard band 807b. Other examples may omit the guard bands 807a and 807b.

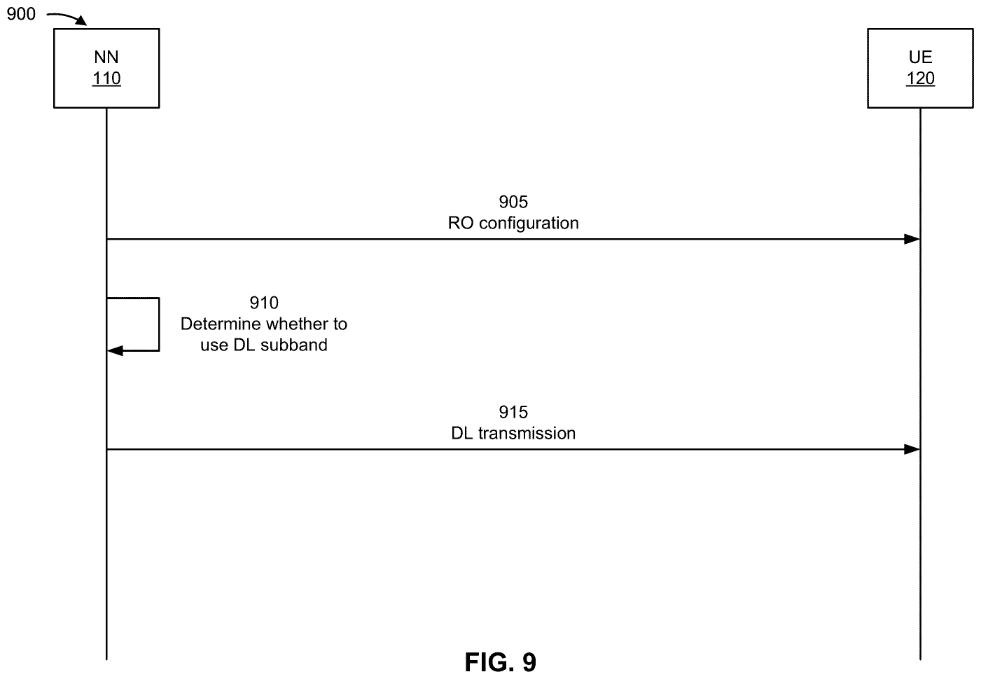

As further shown in FIG. 8A, a network may schedule a downlink transmission 809 in the SBFD slot. For example, the downlink transmission 809 may include a transmission associated with a PDSCH. As described in connection with FIG. 9, the UE 120 may determine whether to receive the downlink transmission 809 based on an RRC parameter from a network and/or whether the downlink transmission 809 is dynamic or configured.

In FIG. 8A, the downlink transmission 809 is included in the first downlink subband 805a in the SBFD slot. Other examples may include the downlink transmission 809 additionally or alternatively included in the second downlink subband 805b in the SBFD slot. Example 850 of FIG. 8B is similar to example 800 of FIG. 8A except that downlink transmissions are not allowed in the SBFD slot because of the RO 803, as described in connection with FIG. 9.

As indicated above, FIGS. 8A-8B are provided as examples. Other examples may differ from what is described with respect to FIGS. 8A-8B.

FIG. 9 is a diagram illustrating an example 900 associated with downlink transmissions in SBFD symbols, in accordance with the present disclosure. As shown in FIG. 9, a network node 110 and a UE 120 may communicate with one another (e.g., using a wireless network, such as wireless network 100 of FIG. 1). The network node 110 may communicate directly (e.g., using an RU 340) or indirectly (e.g., by using a controller of the RU 340, such as a DU 330 and/or a CU 310).

As shown by reference number 905, the network node 110 may transmit, and the UE 120 may receive, a configuration associated with an RO. The RO may be located in one or more SBFD symbols (e.g., as described in connection with FIGS. 8A and 8B).

As shown by reference number 910, the network node 110 may determine whether to transmit a downlink transmission in the one or more SBFD symbols based at least in part on the configuration. In some aspects, the downlink transmission may be associated with a PDSCH.

In some aspects, the network node 110 may determine to transmit (and the UE 120 may determine to receive) based on the downlink transmission being scheduled by DCI but may determine to refrain from transmitting for a configured downlink transmission scheduled by a higher layer parameter (e.g., scheduled by RRC and/or a MAC-CE). Accordingly, the network node 110 may transmit only dynamic downlink transmissions in the one or more SBFD symbols. Alternatively, the network node 110 may transmit both dynamic and configured downlink transmissions in the one or more SBFD symbols. Additionally, or alternatively, the network node 110 may determine to transmit further based on a priority associated with the downlink transmission. For example, the network node 110 may transmit only downlink transmissions associated with a priority that satisfies a priority threshold. Additionally, or alternatively, the network node 110 may determine to transmit (and the UE 120 may determine to receive) based on an RRC parameter from the network node 110. For example, the RRC parameter may include a field that indicates whether all downlink transmissions are allowed, only dynamic transmissions are allowed, or no downlink transmissions are allowed.

As shown by reference number 915, the network node 110 selectively transmits, and the UE 120 selectively receives, in the one or more SBFD symbols. For example, the network node 110 transmits, or refrains from transmitting, in a downlink subband of the one or more SBFD symbols according to the determination described in connection with reference number 910. Similarly, the UE 120 receives, or refrains from receiving, in the downlink subband of the one or more SBFD symbols according to the determination described in connection with reference number 910. Additionally, the UE 120 does not transmit (and the network node 110 does not receive) a preamble in the RO, such that the downlink transmission does not collide with a preamble.

By using techniques as described in connection with FIG. 9, the network node 110 may selectively transmit in the one or more SBFD symbols that are configured for the RO. As a result, the network node 110 reduces downlink latency with the UE 120.

As indicated above, FIG. 9 is provided as an example. Other examples may differ from what is described with respect to FIG. 9.

FIG. 10 is a diagram illustrating an example process 1000 performed, for example, by a UE, in accordance with the present disclosure. Example process 1000 is an example where the UE (e.g., UE 120 and/or apparatus 1400 of FIG. 14) performs operations associated with transmitting uplink transmissions in SBFD symbols.

As shown in FIG. 10, in some aspects, process 1000 may include receiving a configuration associated with a downlink transmission in one or more SBFD symbols (block 1010). For example, the UE (e.g., using reception component 1402 and/or communication manager 1406, depicted in FIG. 14) may receive a configuration associated with a downlink transmission in one or more SBFD symbols, as described herein.

As further shown in FIG. 10, in some aspects, process 1000 may include selectively transmitting an uplink transmission in the one or more SBFD symbols based at least in part on the configuration (block 1020). For example, the UE (e.g., using transmission component 1404 and/or communication manager 1406, depicted in FIG. 14) may selectively transmit an uplink transmission in the one or more SBFD symbols based at least in part on the configuration, as described herein.

Process 1000 may include additional aspects, such as any single aspect or any combination of aspects described below and/or in connection with one or more other processes described elsewhere herein.

In a first aspect, the downlink transmission includes an SSB associated with a serving cell, and the UE refrains from transmitting the uplink transmission based on the configuration indicating that the SSB is indicated for measurement.

In a second aspect, alone or in combination with the first aspect, the downlink transmission is included in one or more downlink subbands in the one or more SBFD symbols.

In a third aspect, alone or in combination with one or more of the first and second aspects, the downlink transmission is included in at least one uplink subband in the one or more SBFD symbols.

In a fourth aspect, alone or in combination with one or more of the first through third aspects, the downlink transmission includes an SSB associated with a serving cell, and the UE transmits the uplink transmission based on the configuration indicating that the SSB is not indicated for measurement.

In a fifth aspect, alone or in combination with one or more of the first through fourth aspects, process 1000 includes receiving (e.g., using reception component 1402 and/or communication manager 1406) DCI associated with the uplink transmission in the one or more SBFD symbols, such that the UE transmits based on the uplink transmission being scheduled by the DCI.

In a sixth aspect, alone or in combination with one or more of the first through fifth aspects, process 1000 includes receiving (e.g., using reception component 1402 and/or communication manager 1406) a higher layer parameter associated with the uplink transmission in the one or more SBFD symbols, such that the UE refrains from transmitting based on the uplink transmission being scheduled by the higher layer parameter.

In a seventh aspect, alone or in combination with one or more of the first through sixth aspects, process 1000 includes determining (e.g., using communication manager 1406) a priority associated with the uplink transmission, such that the UE selectively transmits based on the priority associated with the uplink transmission.

In an eighth aspect, alone or in combination with one or more of the first through seventh aspects, the downlink transmission includes an RLM-RS.

In a ninth aspect, alone or in combination with one or more of the first through eighth aspects, the downlink transmission includes a reference signal for RRM or RLM.

In a tenth aspect, alone or in combination with one or more of the first through ninth aspects, the downlink transmission includes an SSB associated with an SMTC, and the UE refrains from transmitting based on the configuration indicating that the SSB is indicated for measurement.

In an eleventh aspect, alone or in combination with one or more of the first through tenth aspects, process 1000 includes receiving (e.g., using reception component 1402 and/or communication manager 1406) an RRC parameter, such that the UE selectively transmits the uplink transmission based on the RRC parameter.

In a twelfth aspect, alone or in combination with one or more of the first through eleventh aspects, the RRC parameter includes a bitmap.

In a thirteenth aspect, alone or in combination with one or more of the first through twelfth aspects, the RRC parameter includes a single field.

In a fourteenth aspect, alone or in combination with one or more of the first through thirteenth aspects, the RRC parameter is associated with an SMTC window.

In a fifteenth aspect, alone or in combination with one or more of the first through fourteenth aspects, the RRC parameter is associated with a pattern in time.

In a sixteenth aspect, alone or in combination with one or more of the first through fifteenth aspects, the downlink transmission includes an SSB associated with an SMTC, and the UE transmits the uplink transmission based on the configuration indicating that the SSB is not indicated for measurement.

In a seventeenth aspect, alone or in combination with one or more of the first through sixteenth aspects, the downlink transmission includes an SSB associated with an SMTC, and the UE refrains from transmitting the uplink transmission based on the SSB being associated with a measurement gap.

In an eighteenth aspect, alone or in combination with one or more of the first through seventeenth aspects, the downlink transmission includes a CSI-RS.

In a nineteenth aspect, alone or in combination with one or more of the first through eighteenth aspects, the downlink transmission is associated with CSS 0.

In a twentieth aspect, alone or in combination with one or more of the first through nineteenth aspects, the downlink transmission is associated with CORESET 0.

In a twenty-first aspect, alone or in combination with one or more of the first through twentieth aspects, the downlink transmission includes a TRS.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110 and/or apparatus 1500 of FIG. 15) performs operations associated with receiving uplink transmissions in SBFD symbols.

As shown in FIG. 11, in some aspects, process 1100 may include transmitting a configuration associated with a downlink transmission in one or more SBFD symbols (block 1110). For example, the network node (e.g., using transmission component 1504 and/or communication manager 1506, depicted in FIG. 15) may transmit a configuration associated with a downlink transmission in one or more SBFD symbols, as described herein.

As further shown in FIG. 11, in some aspects, process 1100 may include selectively monitoring for an uplink transmission in the one or more SBFD symbols based at least in part on the configuration (block 1120). For example, the network node (e.g., using reception component 1502 and/or communication manager 1506, depicted in FIG. 15) may selectively monitor for an uplink transmission in the one or more SBFD symbols based at least in part on the configuration, as described herein.

Process 1100 may include additional aspects, such as any single aspect or any combination of aspects described below and/or in connection with one or more other processes described elsewhere herein.

In a first aspect, the downlink transmission includes an SSB associated with a serving cell, and the network node refrains from monitoring for the uplink transmission based on the configuration indicating that the SSB is indicated for measurement.

In a second aspect, alone or in combination with the first aspect, the downlink transmission is included in one or more downlink subbands in the one or more SBFD symbols.

In a third aspect, alone or in combination with one or more of the first and second aspects, the downlink transmission is included in at least one uplink subband in the one or more SBFD symbols.

In a fourth aspect, alone or in combination with one or more of the first through third aspects, the downlink transmission includes an SSB associated with a serving cell, and the network node monitors for the uplink transmission based on the configuration indicating that the SSB is not indicated for measurement.

In a fifth aspect, alone or in combination with one or more of the first through fourth aspects, process 1100 includes transmitting (e.g., using transmission component 1504 and/or communication manager 1506) DCI associated with the uplink transmission in the one or more SBFD symbols, such that the network node monitors for the uplink transmission based on the uplink transmission being scheduled by the DCI.

In a sixth aspect, alone or in combination with one or more of the first through fifth aspects, process 1100 includes transmitting (e.g., using transmission component 1504 and/or communication manager 1506) a higher layer parameter associated with the uplink transmission, such that the network node refrains from monitoring for the uplink transmission based on the uplink transmission being scheduled by the higher layer parameter.

In a seventh aspect, alone or in combination with one or more of the first through sixth aspects, process 1100 includes determining (e.g., using communication manager 1506) a priority associated with the uplink transmission, such that the network node selectively monitors for the uplink transmission based on the priority associated with the uplink transmission.

In an eighth aspect, alone or in combination with one or more of the first through seventh aspects, the downlink transmission includes an RLM-RS.

In a ninth aspect, alone or in combination with one or more of the first through eighth aspects, the downlink transmission includes a reference signal for RRM or RLM.

In a tenth aspect, alone or in combination with one or more of the first through ninth aspects, the downlink transmission includes an SSB associated with an SMTC, and the network node refrains from monitoring for the uplink transmission based on the configuration indicating that the SSB is indicated for measurement.

In an eleventh aspect, alone or in combination with one or more of the first through tenth aspects, process 1100 includes transmitting (e.g., using transmission component 1504 and/or communication manager 1506) an RRC parameter, such that the network node selectively monitors for the uplink transmission based on the RRC parameter.

In a twelfth aspect, alone or in combination with one or more of the first through eleventh aspects, the RRC parameter includes a bitmap.

In a thirteenth aspect, alone or in combination with one or more of the first through twelfth aspects, the RRC parameter includes a single field.

In a fourteenth aspect, alone or in combination with one or more of the first through thirteenth aspects, the RRC parameter is associated with an SMTC window.

In a fifteenth aspect, alone or in combination with one or more of the first through fourteenth aspects, the RRC parameter is associated with a pattern in time.

In a sixteenth aspect, alone or in combination with one or more of the first through fifteenth aspects, the downlink transmission includes an SSB associated with an SMTC, and the network node monitors for the uplink transmission based on the configuration indicating that the SSB is not indicated for measurement.

In a seventeenth aspect, alone or in combination with one or more of the first through sixteenth aspects, the downlink transmission includes an SSB associated with an SMTC, and the network node refrains from monitoring for the uplink transmission based on the SSB being associated with a measurement gap.

In an eighteenth aspect, alone or in combination with one or more of the first through seventeenth aspects, the downlink transmission includes a CSI-RS.

In a nineteenth aspect, alone or in combination with one or more of the first through eighteenth aspects, the downlink transmission is associated with CSS 0.

In a twentieth aspect, alone or in combination with one or more of the first through nineteenth aspects, the downlink transmission is associated with CORESET 0.

In a twenty-first aspect, alone or in combination with one or more of the first through twentieth aspects, the downlink transmission includes a TRS.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120 and/or apparatus 1400 of FIG. 14) performs operations associated with receiving downlink transmissions in SBFD symbols.

As shown in FIG. 12, in some aspects, process 1200 may include receiving a configuration associated with an RO in one or more SBFD symbols (block 1210). For example, the UE (e.g., using reception component 1402 and/or communication manager 1406, depicted in FIG. 14) may receive a configuration associated with an RO in one or more SBFD symbols, as described herein.

As further shown in FIG. 12, in some aspects, process 1200 may include selectively receiving a downlink transmission in the one or more SBFD symbols based at least in part on the configuration (block 1220). For example, the UE (e.g., using reception component 1402 and/or communication manager 1406, depicted in FIG. 14) may selectively receive a downlink transmission in the one or more SBFD symbols based at least in part on the configuration, as described herein.

Process 1200 may include additional aspects, such as any single aspect or any combination of aspects described below and/or in connection with one or more other processes described elsewhere herein.

In a first aspect, the UE does not transmit a preamble in the RO.

In a second aspect, alone or in combination with the first aspect, the downlink transmission is associated with a PDSCH.

In a third aspect, alone or in combination with one or more of the first and second aspects, the downlink transmission includes a CSI-RS.

In a fourth aspect, alone or in combination with one or more of the first through third aspects, process 1200 includes receiving (e.g., using reception component 1402 and/or communication manager 1406) DCI associated with the downlink transmission in the one or more SBFD symbols, such that the UE receives the downlink transmission based on the downlink transmission being scheduled by the DCI.

In a fifth aspect, alone or in combination with one or more of the first through fourth aspects, process 1200 includes receiving (e.g., using reception component 1402 and/or communication manager 1406) a message associated with configured scheduling of the downlink transmission, such that the UE refrains from receiving the downlink transmission based on the downlink transmission being associated with the configured scheduling.

In a sixth aspect, alone or in combination with one or more of the first through fifth aspects, process 1200 includes receiving (e.g., using reception component 1402 and/or communication manager 1406) an RRC parameter, such that the UE selectively receives the downlink transmission based on the RRC parameter.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110 and/or apparatus 1500 of FIG. 15) performs operations associated with transmitting downlink transmissions in SBFD symbols.

As shown in FIG. 13, in some aspects, process 1300 may include transmitting a configuration associated with an RO in one or more SBFD symbols (block 1310). For example, the network node (e.g., using transmission component 1504 and/or communication manager 1506, depicted in FIG. 15) may transmit a configuration associated with an RO in one or more SBFD symbols, as described herein.

As further shown in FIG. 13, in some aspects, process 1300 may include selectively transmitting a downlink transmission in the one or more SBFD symbols based at least in part on the configuration (block 1320). For example, the network node (e.g., using transmission component 1504 and/or communication manager 1506, depicted in FIG. 15) may selectively transmit a downlink transmission in the one or more SBFD symbols based at least in part on the configuration, as described herein.

Process 1300 may include additional aspects, such as any single aspect or any combination of aspects described below and/or in connection with one or more other processes described elsewhere herein.

In a first aspect, the network node does not receive a preamble in the RO.

In a second aspect, alone or in combination with the first aspect, the downlink transmission is associated with a PDSCH.

In a third aspect, alone or in combination with one or more of the first and second aspects, the downlink transmission includes a CSI-RS.

In a fourth aspect, alone or in combination with one or more of the first through third aspects, process 1300 includes transmitting (e.g., using transmission component 1504 and/or communication manager 1506) DCI associated with the downlink transmission in the one or more SBFD symbols, such that the network node transmits the downlink transmission based on the downlink transmission being scheduled by the DCI.

In a fifth aspect, alone or in combination with one or more of the first through fourth aspects, process 1300 includes transmitting (e.g., using transmission component 1504 and/or communication manager 1506) a message associated with configured scheduling of the downlink transmission, such that the network node refrains from transmitting the downlink transmission based on the downlink transmission being associated with the configured scheduling.

In a sixth aspect, alone or in combination with one or more of the first through fifth aspects, process 1300 includes transmitting (e.g., using transmission component 1504 and/or communication manager 1506) an RRC parameter, such that the network node selectively transmits the downlink transmission based on the RRC parameter.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 6-9. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

In some aspects, the reception component 1402 may receive a configuration (e.g., from the apparatus 1408) associated with a downlink transmission in one or more SBFD symbols. The transmission component 1404 may selectively transmit an uplink transmission (e.g., to the apparatus 1408) in the one or more SBFD symbols based at least in part on the configuration. In one example, the reception component 1402 may receive DCI (e.g., from the apparatus 1408) associated with the uplink transmission in the one or more SBFD symbols, and the transmission component 1404 may transmit the uplink transmission (e.g., to the apparatus 1408) based on the uplink transmission being scheduled by the DCI. In another example, the reception component 1402 may receive a higher layer parameter (e.g., from the apparatus 1408) associated with the uplink transmission in the one or more SBFD symbols, and the transmission component 1404 refrains from transmitting the uplink transmission (e.g., to the apparatus 1408) based on the uplink transmission being scheduled by the higher layer parameter. In another example, the communication manager 1406 may determine a priority associated with the uplink transmission, such that the transmission component 1404 selectively transmits the uplink transmission (e.g., to the apparatus 1408) based on the priority associated with the uplink transmission. In another example, the reception component 1402 may receive an RRC parameter (e.g., from the apparatus 1408), such that the transmission component 1404 selectively transmits the uplink transmission (e.g., to the apparatus 1408) based on the RRC parameter.

Additionally, or alternatively, the reception component 1402 may receive a configuration (e.g., from the apparatus 1408) associated with an RO in one or more SBFD symbols. The reception component 1402 may selectively receive a downlink transmission (e.g., from the apparatus 1408) in the one or more SBFD symbols based at least in part on the configuration. In one example, the reception component 1402 may receive DCI (e.g., from the apparatus 1408) associated with the downlink transmission in the one or more SBFD symbols, and the reception component 1402 may receive the downlink transmission (e.g., from the apparatus 1408) based on the downlink transmission being scheduled by the DCI. In another example, the reception component 1402 may receive a message (e.g., from the apparatus 1408) associated with configured scheduling of the downlink transmission, and the reception component 1402 may refrain from receiving the downlink transmission (e.g., from the apparatus 1408) based on the downlink transmission being associated with the configured scheduling. In another example, the reception component 1402 may receive an RRC parameter (e.g., from the apparatus 1408), such that the reception component 1402 selectively receives the downlink transmission (e.g., from the apparatus 1408) based on the RRC parameter.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 6-9. Additionally, or alternatively, the apparatus 1500 may be configured to perform one or more processes described herein, such as process 1100 of FIG. 11, process 1300 of FIG. 13, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

In some aspects, the transmission component 1504 may transmit a configuration (e.g., to the apparatus 1508) associated with a downlink transmission in one or more SBFD symbols. The reception component 1502 may selectively monitor for an uplink transmission (e.g., from the apparatus 1508) in the one or more SBFD symbols based at least in part on the configuration. In one example, the transmission component 1504 may transmit DCI (e.g., to the apparatus 1508) associated with the uplink transmission in the one or more SBFD symbols, and the reception component 1502 may monitor for the uplink transmission (e.g., from the apparatus 1508) based on the uplink transmission being scheduled by the DCI. In another example, the transmission component 1504 may transmit a higher layer parameter (e.g., to the apparatus 1508) associated with the uplink transmission, and the reception component 1502 may refrain from monitoring for the uplink transmission (e.g., from the apparatus 1508) based on the uplink transmission being scheduled by the higher layer parameter. In another example, the communication manager 1506 may determine a priority associated with the uplink transmission, such that the reception component 1502 selectively monitors for the uplink transmission (e.g., from the apparatus 1508) based on the priority associated with the uplink transmission. In another example, the transmission component 1504 may transmit an RRC parameter (e.g., to the apparatus 1508), such that the reception component 1502 selectively monitors for the uplink transmission (e.g., from the apparatus 1508) based on the RRC parameter.

Additionally, or alternatively, the transmission component 1504 may transmit a configuration (e.g., to the apparatus 1508) associated with an RO in one or more SBFD symbols. The transmission component 1504 may selectively transmit a downlink transmission (e.g., to the apparatus 1508) in the one or more SBFD symbols based at least in part on the configuration. In one example, the transmission component 1504 may transmit DCI (e.g., to the apparatus 1508) associated with the downlink transmission in the one or more SBFD symbols, and the transmission component 1504 may transmit the downlink transmission (e.g., to the apparatus 1508) based on the downlink transmission being scheduled by the DCI. In another example, the transmission component 1504 may transmit (e.g., to the apparatus 1508) a message associated with configured scheduling of the downlink transmission, and the transmission component 1504 may refrain from transmitting the downlink transmission (e.g., to the apparatus 1508) based on the downlink transmission being associated with the configured scheduling. In another example, the transmission component 1504 may transmit an RRC parameter (e.g., to the apparatus 1508), such that the transmission component 1504 selectively transmits the downlink transmission (e.g., to the apparatus 1508) based on the RRC parameter.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving a configuration, from a network, associated with a downlink transmission in one or more subband full duplex (SBFD) symbols; and selectively transmitting an uplink transmission in the one or more SBFD symbols based at least in part on the configuration.

Aspect 2: The method of Aspect 1, wherein the downlink transmission comprises a synchronization signal block (SSB) associated with a serving cell, and the UE refrains from transmitting the uplink transmission based on the configuration indicating that the SSB is indicated for measurement.

Aspect 3: The method of any of Aspects 1-2, wherein the downlink transmission is included in one or more downlink subbands in the one or more SBFD symbols.

Aspect 4: The method of any of Aspects 1-3, wherein the downlink transmission is included in at least one uplink subband in the one or more SBFD symbols.

Aspect 5: The method of any of Aspects 1-4, wherein the downlink transmission comprises a synchronization signal block (SSB) associated with a serving cell, and the UE transmits the uplink transmission based on the configuration indicating that the SSB is not indicated for measurement.

Aspect 6: The method of any of Aspects 1-5, further comprising: receiving downlink control information (DCI) associated with the uplink transmission in the one or more SBFD symbols, wherein the UE transmits the uplink transmission based on the uplink transmission being scheduled by the DCI.

Aspect 7: The method of any of Aspects 1-6, further comprising: receiving a higher layer parameter associated with the uplink transmission in the one or more SBFD symbols, wherein the UE refrains from transmitting the uplink transmission based on the uplink transmission being scheduled by the higher layer parameter.

Aspect 8: The method of any of Aspects 1-7, further comprising: determining a priority associated with the uplink transmission, wherein the UE selectively transmits the uplink transmission based on the priority associated with the uplink transmission.

Aspect 9: The method of any of Aspects 1-8, wherein the downlink transmission comprises a radio link management reference signal (RLM-RS).

Aspect 10: The method of any of Aspects 1-9, wherein the downlink transmission comprises a reference signal for radio resource management or radio link management.

Aspect 11: The method of any of Aspects 1-10, wherein the downlink transmission comprises a synchronization signal block (SSB) associated with an SSB measurement timing configuration, and the UE refrains from transmitting the uplink transmission based on the configuration indicating that the SSB is indicated for measurement.

Aspect 12: The method of any of Aspects 1-10, wherein the downlink transmission comprises a synchronization signal block (SSB) associated with an SSB measurement timing configuration, and the UE transmits the uplink transmission based on the configuration indicating that the SSB is not indicated for measurement.

Aspect 13: The method of any of Aspects 1-10, wherein the downlink transmission comprises a synchronization signal block (SSB) associated with an SSB measurement timing configuration, and the UE refrains from transmitting the uplink transmission based on the SSB being associated with a measurement gap.

Aspect 14: The method of any of Aspects 1-13, further comprising: receiving a radio resource control (RRC) parameter, wherein the UE selectively transmits the uplink transmission based on the RRC parameter.

Aspect 15: The method of Aspect 14, wherein the RRC parameter comprises a bitmap.

Aspect 16: The method of Aspect 14, wherein the RRC parameter comprises a single field.

Aspect 17: The method of Aspect 14, wherein the RRC parameter is associated with a synchronization signal block measurement timing configuration window.

Aspect 18: The method of Aspect 14, wherein the RRC parameter is associated with a pattern in time.

Aspect 19: The method of any of Aspects 1-18, wherein the downlink transmission is associated with an initial common search space (CSS 0).

Aspect 20: The method of any of Aspects 1-19, wherein the downlink transmission is associated with an initial control resource set (CORESET 0).

Aspect 21: The method of any of Aspects 1-18, wherein the downlink transmission comprises a channel state information reference signal (CSI-RS).

Aspect 22: The method of any of Aspects 1-18, wherein the downlink transmission comprises a tracking reference signal (TRS).

Aspect 23: A method of wireless communication performed by a network node, comprising: transmitting a configuration associated with a downlink transmission in one or more subband full duplex (SBFD) symbols; and selectively monitoring for an uplink transmission in the one or more SBFD symbols based at least in part on the configuration.

Aspect 24: The method of Aspect 23, wherein the downlink transmission comprises a synchronization signal block (SSB) associated with a serving cell, and the network node refrains from monitoring for the uplink transmission based on the configuration indicating that the SSB is indicated for measurement.

Aspect 25: The method of any of Aspects 23-24, wherein the downlink transmission is included in one or more downlink subbands in the one or more SBFD symbols.

Aspect 26: The method of any of Aspects 23-25, wherein the downlink transmission is included in at least one uplink subband in the one or more SBFD symbols.

Aspect 27: The method of any of Aspects 23-26, wherein the downlink transmission comprises a synchronization signal block (SSB) associated with a serving cell, and the network node monitors for the uplink transmission based on the configuration indicating that the SSB is not indicated for measurement.

Aspect 28: The method of any of Aspects 23-27, further comprising: transmitting downlink control information (DCI) associated with the uplink transmission in the one or more SBFD symbols, wherein the network node monitors for the uplink transmission based on the uplink transmission being scheduled by the DCI.

Aspect 29: The method of any of Aspects 23-28, further comprising: transmitting a higher layer parameter associated with the uplink transmission, wherein the network node refrains from monitoring for the uplink transmission based on the uplink transmission being scheduled by the higher layer parameter.

Aspect 30: The method of any of Aspects 23-29, further comprising: determining a priority associated with the uplink transmission, wherein the network node selectively monitors for the uplink transmission based on the priority associated with the uplink transmission.

Aspect 31: The method of any of Aspects 23-30, wherein the downlink transmission comprises a radio link management reference signal (RLM-RS).

Aspect 32: The method of any of Aspects 23-31, wherein the downlink transmission comprises a reference signal for radio resource management or radio link management.

Aspect 33: The method of any of Aspects 23-32, wherein the downlink transmission comprises a synchronization signal block (SSB) associated with an SSB measurement timing configuration, and the network node refrains from monitoring for the uplink transmission based on the configuration indicating that the SSB is indicated for measurement.

Aspect 34: The method of any of Aspects 23-32, wherein the downlink transmission comprises a synchronization signal block (SSB) associated with an SSB measurement timing configuration, and the network node monitors for the uplink transmission based on the configuration indicating that the SSB is not indicated for measurement.

Aspect 35: The method of any of Aspects 23-32, wherein the downlink transmission comprises a synchronization signal block (SSB) associated with an SSB measurement timing configuration, and the network node refrains from monitoring for the uplink transmission based on the SSB being associated with a measurement gap.

Aspect 36: The method of any of Aspects 23-35, further comprising: transmitting a radio resource control (RRC) parameter, wherein the network node selectively monitors for the uplink transmission based on the RRC parameter.

Aspect 37: The method of Aspect 36, wherein the RRC parameter comprises a bitmap.

Aspect 38: The method of Aspect 36, wherein the RRC parameter comprises a single field.

Aspect 39: The method of Aspect 36, wherein the RRC parameter is associated with a synchronization signal block measurement timing configuration window.

Aspect 40: The method of Aspect 36, wherein the RRC parameter is associated with a pattern in time.

Aspect 41: The method of any of Aspects 23-40, wherein the downlink transmission is associated with an initial common search space (CSS 0).

Aspect 42: The method of any of Aspects 23-41, wherein the downlink transmission is associated with an initial control resource set (CORESET 0).

Aspect 43: The method of any of Aspects 23-40, wherein the downlink transmission comprises a channel state information reference signal (CSI-RS).

Aspect 44: The method of any of Aspects 23-40, wherein the downlink transmission comprises a tracking reference signal (TRS).

Aspect 45: A method of wireless communication performed by a user equipment (UE), comprising: receiving a configuration, from a network, associated with a random access channel occasion (RO) in one or more subband full duplex (SBFD) symbols; and selectively receiving a downlink transmission in the one or more SBFD symbols based at least in part on the configuration.

Aspect 46: The method of Aspect 45, wherein the UE does not transmit a preamble in the RO.

Aspect 47: The method of any of Aspects 45-46, wherein the downlink transmission is associated with a physical downlink shared channel (PDSCH).

Aspect 48: The method of any of Aspects 45-46, wherein the downlink transmission comprises a channel state information reference signal (CSI-RS).

Aspect 49: The method of any of Aspects 45-48, further comprising: receiving downlink control information (DCI) associated with the downlink transmission in the one or more SBFD symbols, wherein the UE receives the downlink transmission based on the downlink transmission being scheduled by the DCI.

Aspect 50: The method of any of Aspects 45-48, further comprising: receiving a message associated with configured scheduling of the downlink transmission, wherein the UE refrains from receiving the downlink transmission based on the downlink transmission being associated with the configured scheduling.

Aspect 51: The method of any of Aspects 45-50, further comprising: receiving a radio resource control (RRC) parameter, wherein the UE selectively receives the downlink transmission based on the RRC parameter.

Aspect 52: A method of wireless communication performed by a network node, comprising: transmitting a configuration associated with a random access channel occasion (RO) in one or more subband full duplex (SBFD) symbols; and selectively transmitting a downlink transmission in the one or more SBFD symbols based at least in part on the configuration.

Aspect 53: The method of Aspect 52, wherein the network node does not receive a preamble in the RO.

Aspect 54: The method of any of Aspects 52-53, wherein the downlink transmission is associated with a physical downlink shared channel (PDSCH).

Aspect 55: The method of any of Aspects 52-53, wherein the downlink transmission comprises a channel state information reference signal (CSI-RS).

Aspect 56: The method of any of Aspects 52-55, further comprising: transmitting downlink control information (DCI) associated with the downlink transmission in the one or more SBFD symbols, wherein the network node transmits the downlink transmission based on the downlink transmission being scheduled by the DCI.

Aspect 57: The method of any of Aspects 52-55, further comprising: transmitting a message associated with configured scheduling of the downlink transmission, wherein the network node refrains from transmitting the downlink transmission based on the downlink transmission being associated with the configured scheduling.

Aspect 58: The method of any of Aspects 52-57, further comprising: transmitting a radio resource control (RRC) parameter, wherein the network node selectively transmits the downlink transmission based on the RRC parameter.

Aspect 59: An apparatus for wireless communication at a device, comprising a processor; memory coupled with the processor; and instructions stored in the memory and executable by the processor to cause the apparatus to perform the method of one or more of Aspects 1-58.

Aspect 60: A device for wireless communication, comprising one or more memories and one or more processors coupled to the one or more memories, the one or more processors configured to perform the method of one or more of Aspects 1-58.

Aspect 61: An apparatus for wireless communication, comprising at least one means for performing the method of one or more of Aspects 1-58.

Aspect 62: A non-transitory computer-readable medium storing code for wireless communication, the code comprising instructions executable by a processor to perform the method of one or more of Aspects 1-58.

Aspect 63: A non-transitory computer-readable medium storing a set of instructions for wireless communication, the set of instructions comprising one or more instructions that, when executed by one or more processors of a device, cause the device to perform the method of one or more of Aspects 1-58.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured to:
receive a configuration, from a network, associated with a downlink transmission in one or more subband full duplex (SBFD) symbols; and
selectively transmit an uplink transmission in the one or more SBFD symbols based at least in part on the configuration.

2. The apparatus of claim 1, wherein the downlink transmission comprises a synchronization signal block (SSB) associated with a serving cell, and the UE refrains from transmitting the uplink transmission based on the configuration indicating that the SSB is indicated for measurement.

3. The apparatus of claim 1, wherein the downlink transmission is included in one or more downlink subbands in the one or more SBFD symbols.

4. The apparatus of claim 1, wherein the downlink transmission is included in at least one uplink subband in the one or more SBFD symbols.

5. The apparatus of claim 1, wherein the downlink transmission comprises a synchronization signal block (SSB) associated with a serving cell, and the UE transmits the uplink transmission based on the configuration indicating that the SSB is not indicated for measurement.

6. The apparatus of claim 1, wherein the one or more processors are configured to:
receive downlink control information (DCI) associated with the uplink transmission in the one or more SBFD symbols,
wherein the UE transmits the uplink transmission based on the uplink transmission being scheduled by the DCI.

7. The apparatus of claim 1, wherein the one or more processors are configured to:
receive a higher layer parameter associated with the uplink transmission in the one or more SBFD symbols,
wherein the UE refrains from transmitting the uplink transmission based on the uplink transmission being scheduled by the higher layer parameter.

8. The apparatus of claim 1, wherein the one or more processors are configured to:
determine a priority associated with the uplink transmission,
wherein the UE selectively transmits the uplink transmission based on the priority associated with the uplink transmission.

9. The apparatus of claim 1, wherein the downlink transmission comprises a radio link management reference signal (RLM-RS).

10. The apparatus of claim 1, wherein the downlink transmission comprises a reference signal for radio resource management or radio link management.

11. The apparatus of claim 1, wherein the downlink transmission comprises a synchronization signal block (SSB) associated with an SSB measurement timing configuration, and the UE refrains from transmitting the uplink transmission based on the configuration indicating that the SSB is indicated for measurement.

12. The apparatus of claim 1, wherein the one or more processors are configured to:
receive a radio resource control (RRC) parameter,
wherein the UE selectively transmits the uplink transmission based on the RRC parameter.

13. The apparatus of claim 12, wherein the RRC parameter comprises a bitmap.

14. The apparatus of claim 12, wherein the RRC parameter comprises a single field.

15. The apparatus of claim 12, wherein the RRC parameter is associated with a synchronization signal block measurement timing configuration window.

16. The apparatus of claim 12, wherein the RRC parameter is associated with a pattern in time.

17. The apparatus of claim 1, wherein the downlink transmission comprises a synchronization signal block (SSB) associated with an SSB measurement timing configuration, and the UE transmits the uplink transmission based on the configuration indicating that the SSB is not indicated for measurement.

18. The apparatus of claim 1, wherein the downlink transmission comprises a synchronization signal block (SSB) associated with an SSB measurement timing configuration, and the UE refrains from transmitting the uplink transmission based on the SSB being associated with a measurement gap.

19. The apparatus of claim 1, wherein the downlink transmission comprises a channel state information reference signal (CSI-RS) or a tracking reference signal (TRS).

20. The apparatus of claim 1, wherein the downlink transmission is associated with an initial common search space (CSS 0).

21. The apparatus of claim 1, wherein the downlink transmission is associated with an initial control resource set (CORESET 0).

22. An apparatus for wireless communication at a network node, comprising:
one or more memories; and
one or more processors, coupled to the one or more memories, configured to:
transmit a configuration associated with a downlink transmission in one or more subband full duplex (SBFD) symbols; and
selectively monitor for an uplink transmission in the one or more SBFD symbols based at least in part on the configuration.

23. An apparatus for wireless communication at a user equipment (UE), comprising:
one or more memories; and
one or more processors, coupled to the one or more memories, configured to:
receive a configuration, from a network, associated with a random access channel occasion (RO) in one or more subband full duplex (SBFD) symbols; and
selectively receive a downlink transmission in the one or more SBFD symbols based at least in part on the configuration.

24. The apparatus of claim 23, wherein the UE does not transmit a preamble in the RO.

25. The apparatus of claim 23, wherein the downlink transmission is associated with a physical downlink shared channel (PDSCH).

26. The apparatus of claim 23, wherein the downlink transmission comprises a channel state information reference signal (CSI-RS).

27. The apparatus of claim 23, wherein the one or more processors are configured to:
receive downlink control information (DCI) associated with the downlink transmission in the one or more SBFD symbols,
wherein the UE receives the downlink transmission based on the downlink transmission being scheduled by the DCI.

28. The apparatus of claim 23, wherein the one or more processors are configured to:
receive a message associated with configured scheduling of the downlink transmission,
wherein the UE refrains from receiving the downlink transmission based on the downlink transmission being associated with the configured scheduling.

29. The apparatus of claim 23, wherein the one or more processors are configured to:
receive a radio resource control (RRC) parameter,
wherein the UE selectively receives the downlink transmission based on the RRC parameter.

30. An apparatus for wireless communication at a network node, comprising:
one or more memories; and
one or more processors, coupled to the one or more memories, configured to:
transmit a configuration associated with a random access channel occasion (RO) in one or more subband full duplex (SBFD) symbols; and
selectively transmit a downlink transmission in the one or more SBFD symbols based at least in part on the configuration.
